(19) United States
(12) Patent Application Publication
(10) Pub. No.: US 2024/0186515 A1
(43) Pub. Date: Jun. 6, 2024

(54) ELECTROLYTE SOLUTION FOR REDOX FLOW BATTERY INCLUDING ORGANIC ACTIVE MATERIAL AND REDOX FLOW BATTERY USING THE SAME

(71) Applicant: KOREA INSTITUTE OF ENERGY RESEARCH, Daejeon (KR)

(72) Inventors: Seung Hae Hwang, Daejeon (KR); Kyoung-hee Shin, Daejeon (KR); Chang-soo Jin, Sejong-si (KR); Sun-hwa Yeon, Sejong-si (KR); Dong Ha Kim, Daejeon (KR); Se-Kook Park, Daejeon (KR)

(21) Appl. No.: 18/412,527

(22) Filed: Jan. 13, 2024

(30) Foreign Application Priority Data
Nov. 14, 2022 (KR) 10-2022-0151953

(51) Int. Cl. H01M 4/60; H01M 4/02; H01M 8/18

(52) U.S. Cl. CPC H01M 4/60; H01M 8/18; H01M 2004/027; H01M 2004/028; H01M 2300/0002

(57) ABSTRACT

Provided are an electrolyte solution for a redox flow battery including an organic active material having improved solubility and potential and a redox flow battery using the same.

### CROSS-REFERENCE TO RELATED APPLICATIONS

This application claims priority to Korean Patent Application No. 10-2022-0151953, filed Nov. 14, 2022. The entire contents of the above-listed application are hereby incorporated by reference for all purposes.

### TECHNICAL FIELD

The following disclosure relates to an electrolyte solution for a redox flow battery including an organic active material and a redox flow battery using the same.

### BACKGROUND

As the use of fossil fuels increases due to industrial advancement in modern society, emission of harmful gases such as carbon dioxide increases and global warming and environmental pollution resulting from this are becoming a big issue. As a solution to the problem, development of new renewable energy such as solar energy, tidal energy, and wind energy is progressing rapidly, but since the supply of the energy itself is greatly influenced by the weather, there is a problem with continuous energy supply. Therefore, an energy storage system (ESS) which may complement the weakness becomes an element essential for new renewable energy development.

Various things such as a capacity, a lithium battery, and a redox flow battery are being used as an energy storage system. Among the energy storage systems, a redox flow battery is a secondary battery which stores chemical energy of an electrolyte solution as electrical energy using a redox reaction of an active material, and since it allows capacity recovery following mixing solutions, it is stable and has a stack responsible for output and an electrolyte solution unit responsible for capacity which are independently separated, it is a battery system which is advantageous for a large capacity showing an advantage of independently designing output and capacity. In particular, though a vanadium redox flow battery has high current efficiency and cell voltage, the active material is not abundant and the price is relatively high, and sensitivity depending on temperature and low energy density act as an obstacle to commercialization.

Accordingly, many studies for replacing active materials with organic materials cheaper than a metal active material are in progress. The redox flow battery may be divided into an aqueous type or a non-aqueous type, and a redox flow battery based on a non-aqueous electrolyte has an advantage of producing voltage higher than voltage of water decomposition, but due to low solubility and instability of the active material, it has features of low energy density and deteriorated life characteristics. However, an organic material redox flow battery based on an aqueous electrolyte may have a rapid stable reaction, and in particular, the solubility and reactivity of the active material may be improved by synthesis of an organic material.

Therefore, development of an active material which is based on an aqueous electrolyte, shows advantages described above, is cheaper than a metal active material, and has high energy density is needed.

### Related Art Documents

### Patent Documents

(Patent Document 1) Korean Patent Registration No. 10-1677107

### Non-Patent Documents

(Non-Patent Document 1) Korean Chem. Eng. Res., 57(6), 868-873 (2019)

### SUMMARY

An embodiment of the present invention is directed to providing an electrolyte solution for a redox flow battery including an organic active material having improved solubility and potential and a redox flow battery using the same.

In one general aspect, an electrolyte solution for a redox flow battery includes: an organic active material including an ionic compound represented by the following Chemical Formula 1; a supporting electrolyte; and an aqueous solvent:

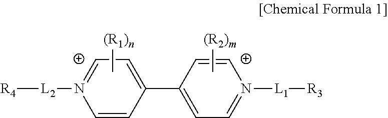

wherein

L₁ and L₂ are independently of each other C1-C7 alkylene;

the alkylene may be substituted by halogen, —COORₐ, —SO₃R_{b}, —COR_{c}, or —NR_{d}Rₑ;

Rₐ to Rₑ are independently of one another hydrogen or C1-C5 alkyl;

R₁ and R₂ are independently of each other hydrogen, hydroxy, C1-C7 alkyl, C1-C7 alkoxy, C6-C20 aryl, C5-C20 heteroaryl, or C6-C20 aryloxy;

R₃ is —(N (Rₚ) (R_{q}) (Rₑ))⁺, —SO₃⁻, —COO⁻, or —PO₃²⁻;

Rₚ to Rᵣ are independently of one another C1-C7 alkyl;

R₄ is

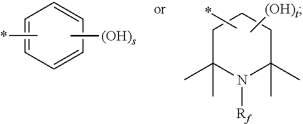

R_{f} is hydrogen or hydroxy;

n and m are independently of each other an integer of 1 to 4;

s is an integer of 1 to 5; and

t is an integer of 1 or 2.

The organic active material may include an ionic compound represented by the following Chemical Formula 2:

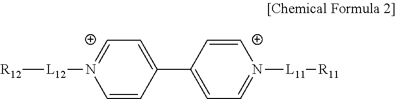

wherein

L₁₁ and L₁₂ are independently of each other C1-C7 alkylene;

the alkylene may be substituted by halogen, —COORₐ, —SO₃R_{b}, —COR_{c}, or —NR_{d}Rₑ;

Rₐ to Rₑ are independently of one another hydrogen or C1-C5 alkyl;

R₁₁ is —(N (Rₚ) (R_{q}) (Rᵣ)⁺, —SO₃⁻, —COO⁻, or —PO₃²⁻;

Rₚ to Rᵣ are independently of one another C1-C7 alkyl;

R₁₂ is

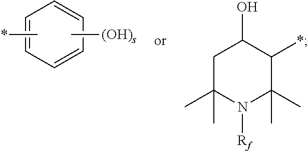

R_{f} is hydrogen or hydroxy; and

s is an integer of 1 to 3.

In addition, the organic active material according to the present invention may include an ionic compound represented by the following Chemical Formula 3:

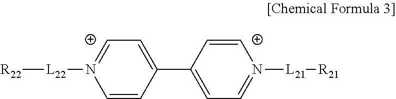

wherein

L₂₁ and L₂₂ are independently of each other C1-C5 alkylene;

the alkylene may be substituted by halogen, —COORₐ, —SO₃R_{b}, —COR_{c}, or —NR_{d}Rₑ;

Rₐ to Rₑ are independently of one another hydrogen or C1-C5 alkyl;

R₂₁ is —(N (Rₚ) (R_{q}) (R_{d}))⁺, —SO₃⁻, —COO⁻, or —PO₃²⁻;

Rₚ to Rᵣ are independently of one another C1-C5 alkyl; and

R₂₂ is

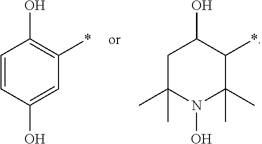

In Chemical Formula 3, L₂₁ and L₂₂ may be independently of each other C1-C3 alkylene; the alkylene may be substituted by halogen, —COORₐ, —SO₃R_{b}, —COR_{c}, or —NR_{d}Rₑ; Rₐ to Rₑ may be independently of one another hydrogen or C1-C3 alkyl; and Rₚ to Rᵣ may be independently of one another C1-C3 alkyl, and the ionic compound included in the organic active material according to an exemplary embodiment of the present invention may be selected from the following compounds:

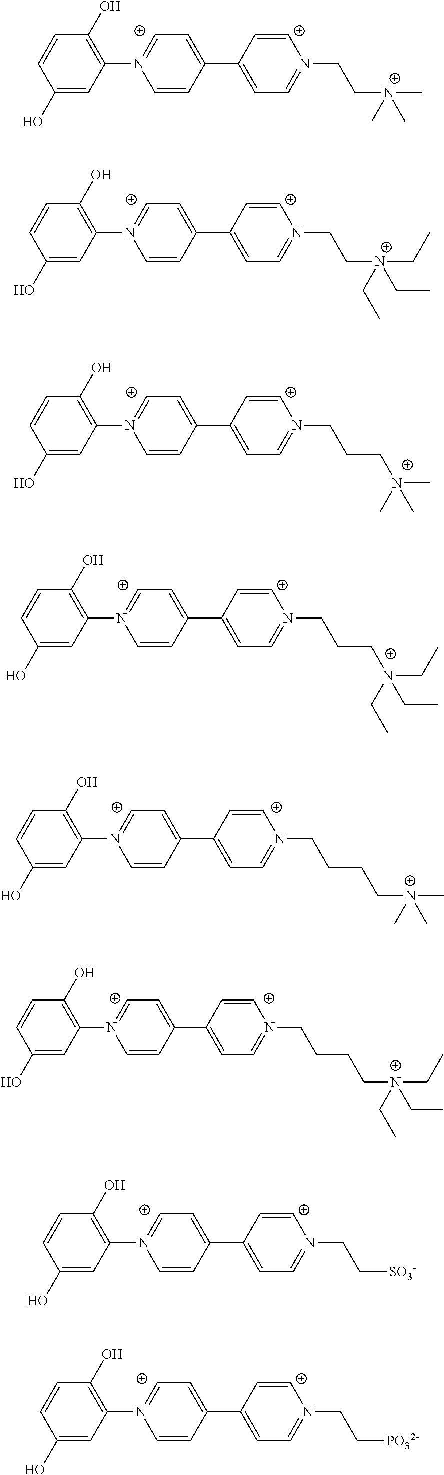

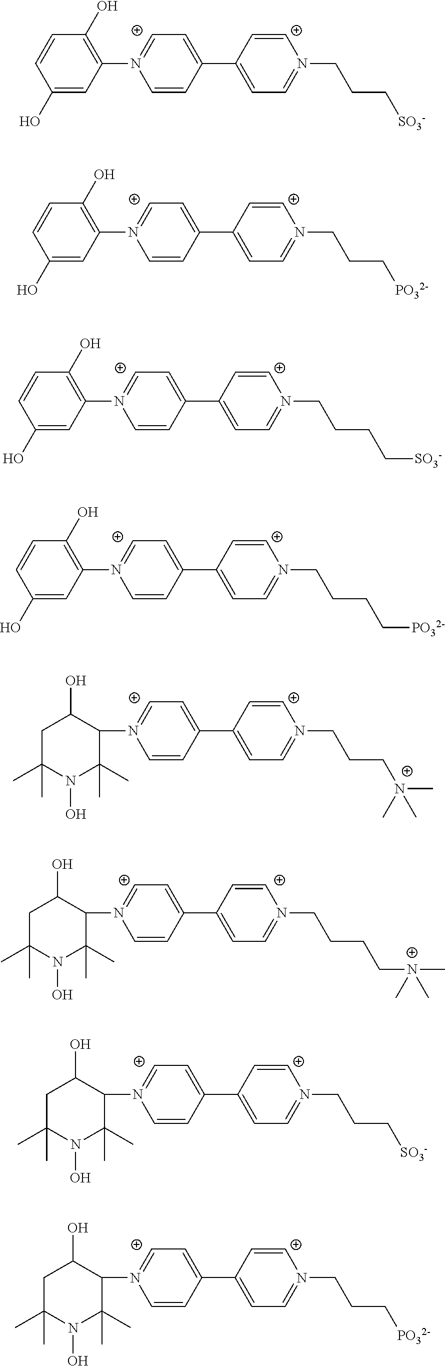

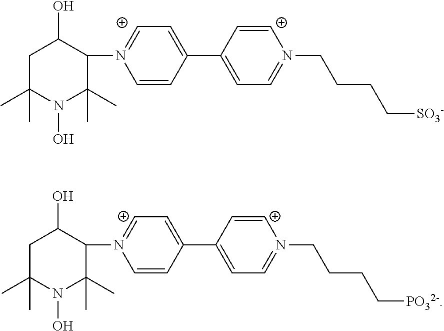

In addition, the organic active material according to an exemplary embodiment may be an active material which may be used alone in a positive electrode and negative electrode, and the organic active material may be included at a concentration of 0.001 to 4.0 M based on the total electrolyte solution.

The supporting electrolyte according to an exemplary embodiment of the present invention may be one or two or more selected from H₂SO₄, Li₂SO₄, Na₂SO₄, K₂SO₄, and LiCl; and the supporting electrolyte may be included at a concentration of 0.5 to 3.0 M based on the total electrolyte solution.

In another general aspect, a redox flow battery includes: a positive electrode cell including the electrolyte solution according to an exemplary embodiment and a positive electrode; a negative electrode cell including the electrolyte solution according to an exemplary embodiment and a negative electrode; and a separator between the positive electrode cell and the negative electrode cell.

The separator may be an anion exchange membrane or a porous membrane.

Other features and aspects will be apparent from the following detailed description, the drawings, and the claims.

### BRIEF DESCRIPTION OF THE DRAWINGS

FIG. 1 is a drawing showing cyclic voltammetry curves of Example 1, Comparative Example 1, and Comparative Example 2.

FIG. 2 is a drawing showing repeated cyclic voltammetry curves at a scanning speed of 300 mV s⁻¹ of Example 1.

FIG. 3 is a drawing showing cyclic voltammetry curves at a scanning speed of 100 mV s⁻¹ of Comparative Example 3 and Example 1.

FIG. 4 is a drawing showing a voltage time curve of a non-flow cell of Example 1.

FIG. 5 is a photograph of measuring solubility in Example 1 and Comparative Example 2.

### DETAILED DESCRIPTION OF EMBODIMENTS

Hereinafter, an electrolyte solution for a redox flow battery including an organic active material of the present invention and a redox flow battery using the same will be described in detail.

The singular form used in the present Inventive steel may be intended to also include a plural form, unless otherwise indicated in the context.

In addition, the numerical range used in the present invention includes all values within the range including the lower limit and the upper limit, increments logically derived in a form and span in a defined range, all double limited values, and all possible combinations of the upper limit and the lower limit in the numerical range defined in different forms. Unless otherwise defined in the specification of the present invention, values which may be outside a numerical range due to experimental error or rounding off of a value are also included in the defined numerical range.

The term “comprise” described in the present invention is an open-ended description having a meaning equivalent to the term such as “is/are provided”, “contain”, “have”, or “is/are characterized”, and does not exclude elements, materials or processes which are not further listed.

Hereinafter, the present invention will be described in detail. Here, technical terms and scientific terms used in the present specification have the general meaning understood by a person skilled in the art unless otherwise defined, and a description for the known function and configuration obscuring the present invention will be omitted in the following description.

The present invention provides an electrolyte solution for a redox flow battery including: an organic active material including an ionic compound represented by the following Chemical Formula 1; a supporting electrolyte; and an aqueous solvent:

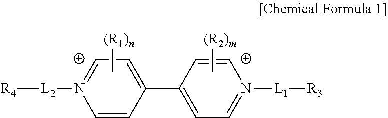

wherein

L₁ and L₂ are independently of each other C1-C7 alkylene;

the alkylene may be substituted by halogen, —COORₐ, —SO₃R_{b}, —COR_{c}, or —NR_{d}Rₑ;

Rₐ to Rₑ are independently of one another hydrogen or C1-C5 alkyl;

R₁ and R₂ are independently of each other hydrogen, hydroxy, C1-C7 alkyl, C1-C7 alkoxy, C6-C20 aryl, C5-C20 heteroaryl, or C6-C20 aryloxy;

R₃ is —(N (Rₚ) (R_{q}) (Rᵣ))⁺, —SO₃⁻, —COO⁻, or —PO₃²⁻;

Rₚ to Rᵣ are independently of one another C1-C7 alkyl;

R₄ is

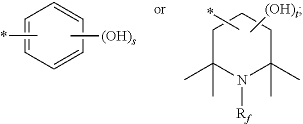

R_{f} is hydrogen or hydroxy;

n and m are independently of each other an integer of 1 to 4;

s is an integer of 1 to 5; and

t is an integer of 1 or 2.

The term “ionic compound” of the present invention is a material which shows ionic properties, may show cationic, anionic, or neutral properties, and may include a counter ion in a compound to become neutral or include an independent salt to become neutral. The counter ion may be, for example, chloride, bromide, or iodide, but is not limited thereto.

The organic active material may include an ionic compound represented by the following Chemical Formula 2:

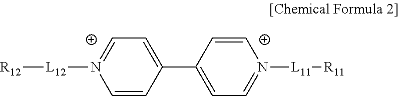

wherein

L₁₁ and L₁₂ are independently of each other C1-C7 alkylene;

the alkylene may be substituted by halogen, —COORₐ, —SO₃R_{b}, —COR_{c}, or —NR_{d}Rₑ;

Rₐ to Rₑ are independently of one another hydrogen or C1-C5 alkyl;

R₁₁ is —(N (Rₚ) (R_{q}) (Rᵣ))⁺, —SO₃⁻, —COO⁻, or —PO₃²⁻;

Rₚ to Rᵣ are independently of one another C1-C7 alkyl;

R₁₂ is

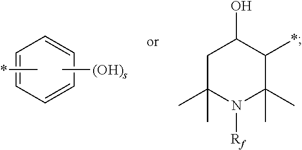

R_{f} is hydrogen or hydroxy; and

s is an integer of 1 to 3.

In addition, the organic active material according to the present invention may include an ionic compound represented by the following Chemical Formula 3:

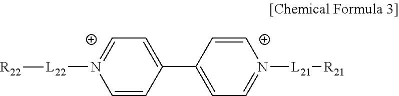

wherein

L₂₁ and L₂₂ are independently of each other C1-C5 alkylene;

the alkylene may be substituted by halogen, —COORₐ, —SO₃R_{b}, —COR_{c}, or —NR_{d}Rₑ;

Rₐ to Rₑ are independently of one another hydrogen or C1-C5 alkyl;

R₂₁ is —(N (Rₚ) (R_{q}) (Rᵣ))⁺, —SO₃⁻, —COO⁻, or —PO₃²⁻;

Rₚ to Rᵣ are independently of one another C1-C5 alkyl; and

R₂₂ is

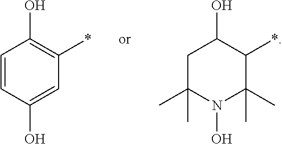

In Chemical Formula 3, L₂₁ and L₂₂ may be independently of each other C1-C3 alkylene; the alkylene may be substituted by halogen, —COORₐ, —SO₃R_{b}, —COR_{c}, or —NR_{d}Rₑ; Rₐ to Rₑ may be independently of one another hydrogen or C1-C3 alkyl; and Rₚ to Rᵣ may be independently of one another C1-C3 alkyl, and the ionic compound included in the organic active material according to an exemplary embodiment of the present invention may be selected from the following compounds:

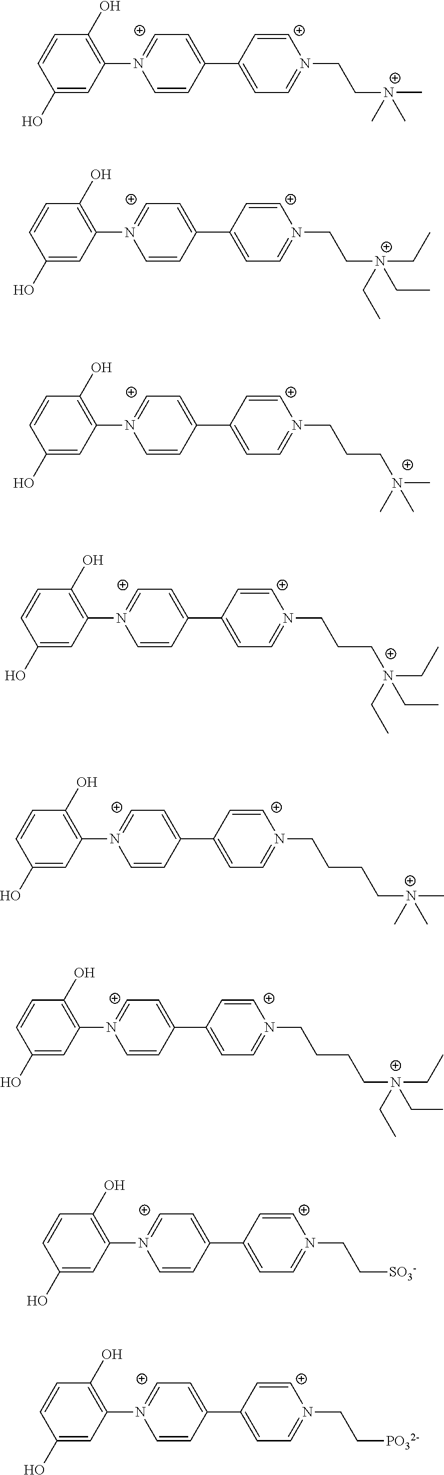

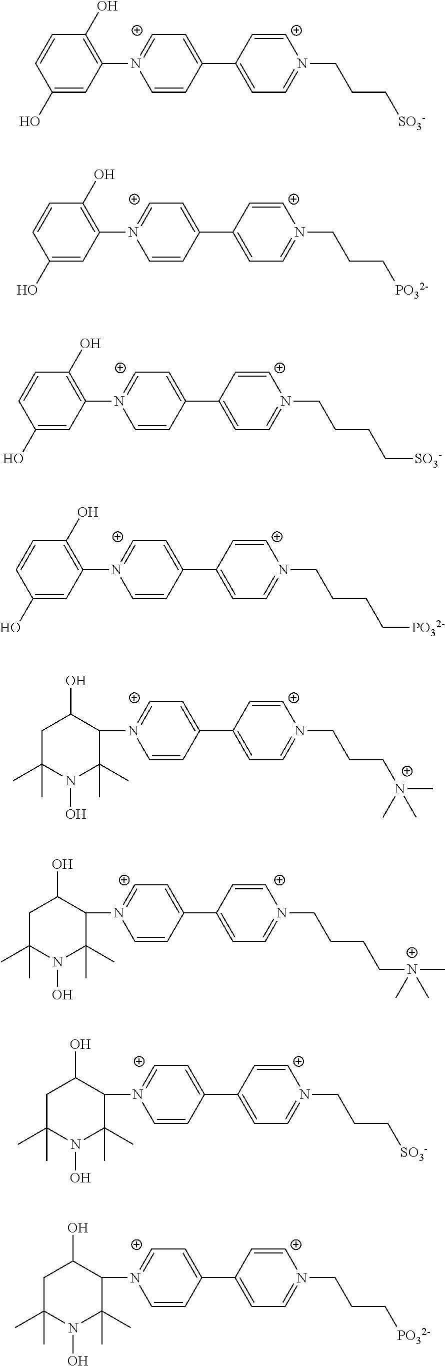

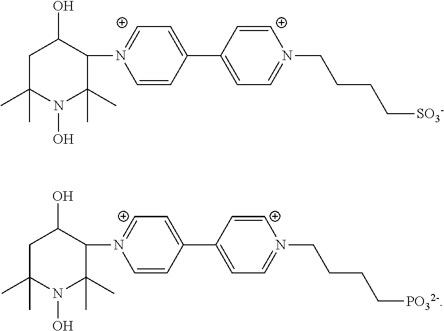

The organic active material according to an exemplary embodiment of the present invention shows positive electrode reactivity by having a specific substituent, has improved solubility, and may show 2-electron reactivity. Therefore, the organic active material of the present invention may be used as a single active material which may be used alone in a positive electrode and a negative electrode and may show long period characteristics, and a redox flow battery adopting the organic active material may show significantly improved efficiency of high energy density.

The organic active material according to an exemplary embodiment may be included at a concentration of 0.001 to 4.0 M, specifically 0.003 to 1.0 M, and more specifically 0.005 to 0.05 M, based on the total electrolyte solution. The electrolyte including the organic active material at the concentration in the above range may show more improved long period characteristics and high energy density, and may be cheap in price to be very economically used in a large-capacity energy storage system.

The supporting electrolyte is an electrolyte containing a chemical species which are not electrically active within a used electrode potential range and have much higher ionic strength and conductivity than those by the active material added to the electrolyte. Therefore, the supporting electrolyte helps a redox reaction of the active material smoothly and also serves to form an ion pair with a redox couple even with a counter ion when an oxidation state of the redox couple changes.

The supporting electrolyte according to an exemplary embodiment of the present invention may be one or two or more selected from H₂SO₄, Li₂SO₄, Na₂SO₄, K₂SO₄, and LiCl, specifically, one or two or more selected from H₂SO₄, Na₂SO₄, and K₂SO₄, and more specifically, Na₂SO₄, but is not limited thereto.

The supporting electrolyte may be included at a concentration of 0.5 to 3.0 M, specifically 0.6 to 2.0 M, and more specifically 0.7 to 1.5 M, based on the total electrolyte solution. The electrolyte solution including the supporting electrolyte in the above range may show more improved durability and electrochemical efficiency.

The present invention provides a redox flow battery including: a positive electrode cell including the electrolyte solution according to an exemplary embodiment and a positive electrode; a negative electrode cell including the electrolyte solution according to an exemplary embodiment and a negative electrode; and a separator between the positive electrode cell and the negative electrode cell.

As the separator, an ion exchange membrane which is used in a conventional redox flow battery may be used without limitation, and for example, may be a fluorine-based polymer, a partial fluorine-based polymer, or a hydrocarbon-based polymer, and more specifically, may be selected from a homocopolymer, an alternating copolymer, a random copolymer, a block copolymer, a multiblock copolymer, and a graft copolymer of one or two or more polymers selected from the group consisting of perfluorosulfonic acid-based polymers, hydrocarbon-based polymers, aromatic sulfone-based polymers, aromatic ketone-based polymers, polybenzimidazole-based polymers, polystyrene-based polymers, polyester-based polymers, polyimide-based polymers, polyvinylidene fluoride-based polymers, polyethersulfone-based polymers, polyphenylene sulfide-based polymers, polyphenylene oxide-based polymers, polyphosphagen-based polymers, polyethylene naphthalate-based polymers, polyester-based polymers, doped polybenzimidazole-based polymers, polyetherketone-based polymers, polyphenylquinoxaline-based polymers, polysulfone-based polymers, sulfonated polyarylene ether-based polymers, sulfonated polyetherketone-based polymers, sulfonated polyetheretherketone-based polymers, sulfonated polyamide-based polymers, sulfonated polyimide-based polymers, sulfonated polyphosphagen-based polymers, sulfonated polystyrene-based polymer and radiation sulfonated low-density polyethylene-g-polystyrene-based polymers. The separator may be an anion exchange membrane or a porous membrane.

The positive electrode and the negative electrode of the present invention may be independently of each other any one or two or more selected from gold (Au), tin (Sn), titanium (Ti), platinum (Pt), platinum-titanium (Pt-Ti), iridium oxide-titanium (IrO-Ti), and carbon. The electrode should have excellent electric conductivity and mechanical strength and should be chemically and electrochemically stable. In addition, when it is applied to a battery, it should show high efficiency, should be cheap, and should be a material of which the oxidation/reduction reaction with an active material is reversible. Considering the criteria, any one or two or more selected from the group consisting of gold (Au), tin (Sn), titanium (Ti), platinum-titanium (Pt-Ti), iridium oxide-titanium (IrO-Ti), and carbon materials may be used as an electrode, and besides, other materials which maintain stability in an acid and a base while satisfying the above criteria may be used as an electrode. The carbon materials are inexpensive, have high chemical resistance in an electrolyte of an acid and a base, and are easy to be surface-treated, and in particular, carbon felt of the carbon materials has an advantage of chemical resistance, stability in a large voltage range, and high strength properties. However, when the electrode is manufactured from only carbon and graphite, it is brittle, and thus, in order to overcome this, a carbon polymer composite electrode in which a binder such as polyvinylidene (PVDF), high density polyethylene (HDPE), polyvinyl acetate (PVA), and polyolefin is mixed with a conductive material such as carbon black and graphite fiber may be used. Specifically, as the electrode, glassy carbon and Pt wire may be used, but the present invention is not limited thereto.

The redox flow battery according to an exemplary embodiment of the present invention may include a reservoir which accommodates a positive electrode electrolyte solution and a negative electrode electrolyte solution, respectively, and may further include a pump which pumps each of them.

Hereinafter, the electrolyte solution for a redox flow battery including the organic active material according to the present invention and the redox flow battery using the same will be described in more detail by the specific examples.

However, the following examples are only a reference for describing the present invention in detail, and the present invention is not limited thereto and may be implemented in various forms. In addition, the terms used herein are only for effectively describing certain examples, and are not intended to limit the present invention.

### [Example 1] Preparation of Compound 2

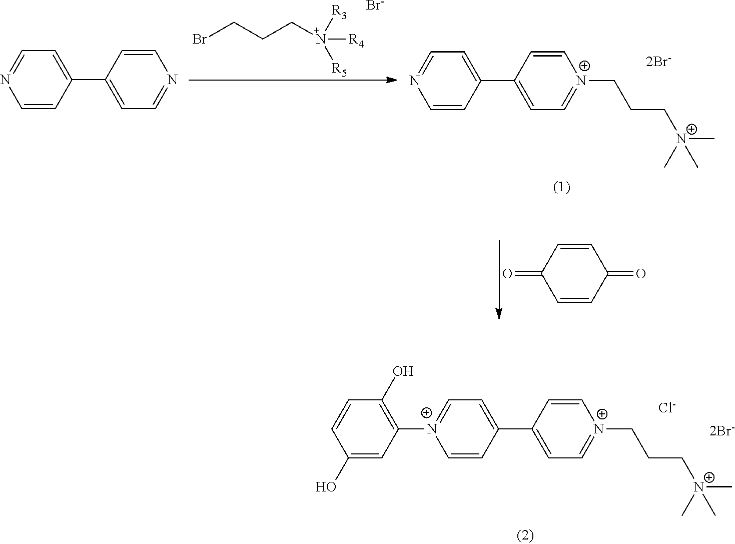

2.991 g (19.15 mmol) of 4,4′-bipyridine and 240 ml of acetonitrile were added to a round flask under an inert atmosphere and dissolved, 5.498 g (21.065 mmol) of (3-bromopropyl)trimethylammonium bromide was added thereto, and a reaction was performed at 60° C. for 72 hours. A filtered ivory solid was washed three times with acetonitrile, and then dried to obtain Compound 1 (yield: 63%).

4.7 ml of acetic acid and 1.081 g (10 mmol) of benzoquinone were added to a flask and dissolved, and 4.173 g (10 mmol) of Compound 1 was slowly added to form a red solid. Thereafter, a reaction was performed at room temperature for 30 minutes. 2.5 ml of water was added to a reactant, 3.0 ml of 18 wt % HCl was added thereto, the temperature was raised to 35° C., and a reaction was performed for 1 hour and 30 minutes. The reactant was cooled to room temperature, 300 ml of diethyl ether was added thereto, the temperature was raised to 35° C., and reflux was performed for 2 hours. The reactant was cooled to room temperature and filtered, and the solid product was dissolved in water and then recrystallized to obtain Compound 2 (yield: 59%).

¹H NMR (500 MHz, D₂O) : δ(ppm) 9.18 (d, 2H) , 9.14 (d, 2H), 8.62 (m, 4H), 7.06 (s, 3H), 4.80 (t, 2H), 3.52 (m, 2H), 3.11 (s, 9H), 2.62 (m, 2H)

### [Example 2] Preparation of Compound 3

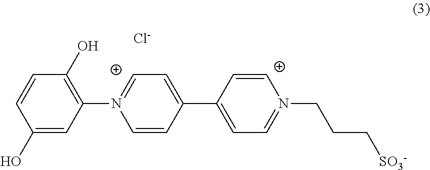

Compound 3 was prepared in the same manner as in Example 1, except that 2.573 g (21.065 mmol) of 3-propanesultone was used instead of using 5.498 g (21.065 mmol) of (3-bromopropyl)trimethylammonium bromide.

### [Example 3] Preparation of Compound 4

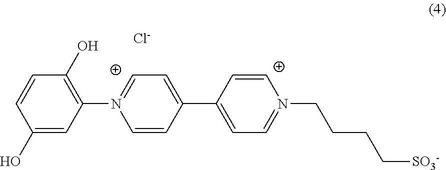

Compound 4 was prepared in the same manner as in Example 1, except that 2.868 g (21.065 mmol) of 4-butanesultone was used instead of using 5.498 g (21.065 mmol) of (3-bromopropyl)trimethylammonium bromide.

### [Example 4] Preparation of Compound 5

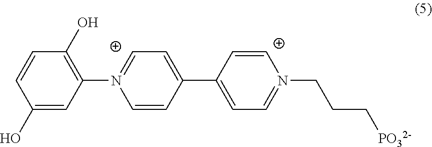

Compound 5 was prepared in the same manner as in Example 1, except that 4.276 g (21.065 mmol) of 3-bromopropylphosphonic acid was used instead of using 5.498 g (21.065 mmol) of (3-bromopropyl)trimethylammonium bromide.

### [Example 5] Preparation of Compound 6

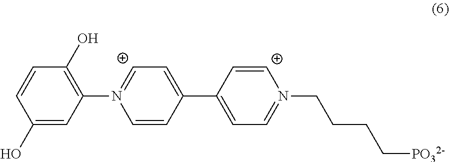

Compound 6 was prepared in the same manner as in Example 1, except that 4.57 g (21.065 mmol) of 4-bromobutylphosphonic acid was used instead of using 5.498 g (21.065 mmol) of (3-bromopropyl)trimethylammonium bromide.

### [Comparative Examples 1] Preparation of Compound 7

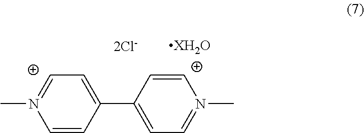

Compound 7 (methyl viologen dichloride hydrate, 2C1ViO, production No. 856177) was purchased from the manufacturer, Sigma-Aldrich.

### [Comparative Examples 2] Preparation of Compound 9

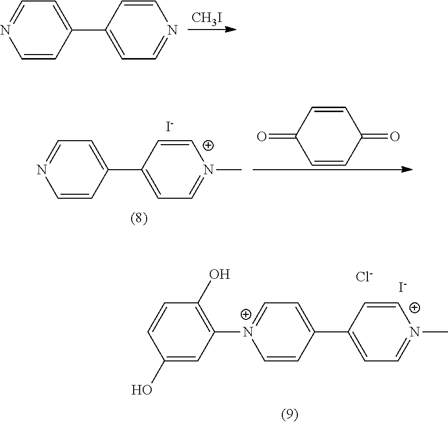

9.996 g (64 mmol) of 4,4′-bipyridine and 160 ml of acetonitrile were added to a round flask under an inert atmosphere and dissolved, 8.928 g (62.9 mmol) of methyl iodide was added thereto, and a reaction was performed at room temperature for 24 hours. A filtered yellow solid was washed twice with acetone, and then dried to obtain Compound 8 (yield: 83%).

9 ml of acetic acid and 1.621 g (15 mmol) of benzoquinone were added to a flask and dissolved, and 4.472 g (15 mmol) of Compound 8 was slowly added to form a red solid. Thereafter, a reaction was performed at room temperature for 30 minutes. 2.5 ml of water was added to a reactant, 4.0 ml of 18 wt % HCl was added thereto, the temperature was raised to 35° C., and a reaction was performed for 1 hour and 30 minutes. The reactant was cooled to room temperature, 300 ml of diethyl ether was added thereto, the temperature was raised to 35° C., and reflux was performed for 2 hours. The reactant was cooled to room temperature and filtered, and the solid product was dissolved in water and then recrystallized to obtain Compound 9 (yield: 52%).

¹H NMR (500 MHz, DMSO-d6, δ): δ=10.555 (1H, S), 9.770 (s, 1H), 9.51 (2H, d), 9.338 (2H, d), 8.879 (4H, dd), 7.129 (2H, m), 7.013 (1H, m), 4.453 (3H, d).

### [Comparative Examples 3] Preparation of Compound 10

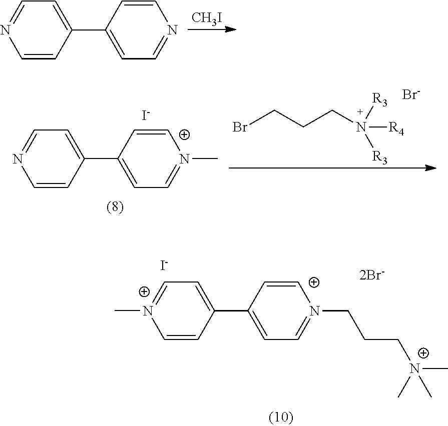

9.996 g (64 mmol) of 4,4′-bipyridine and 160 ml of acetonitrile were added to a round flask under an inert atmosphere and dissolved, 8.928 g (62.9 mmol) of methyl iodide was added thereto, and a reaction was performed at room temperature for 24 hours. A filtered yellow solid was washed twice with acetone, and then dried to obtain Compound 8 (yield: 83%).

A dissolved solution of 5 g (16.8 mmol) of Compound 8 and 60 ml of N,N-dimethylformamide (DMF) and 4.8024 g (18.4 mmol) of (3-bromopropyl)trimethylammonium bromide were added to a round flask in an inert atmosphere, the temperature raised to 95° C., and reflux was performed for 24 hours. The reactant was cooled to room temperature and filtered, and an orange solid product was washed with 20 ml of diethyl ether and dried in a vacuum oven at 60° C. to obtain Compound 10 (yield: 80%).

¹H NMR (500 MHz, D₂O) : δ (ppm) 9.11 (d, 2H) , 8.99 (d, 2H), 8.53 (d, 2H), 8.46 (d, 2H), 4.78 (t, 2H), 4.46 (s, 3H), 3.53-3.50 (m, 2H), 3.12(s, 9H), 2.64-2.60(m,2H)

### Experimental Example 1

### Cyclic Voltammetry

For analysis of electrochemical properties of an electrolyte solution, cyclic voltammetry (CV) was used. The cyclic voltammetry is an electrochemical measurement method which is commonly used a lot, and is a method of obtaining a current-potential curve by scanning an electrode potential of a working electrode with a triangular wave at a constant speed. A method of recording a current flowing when potential is changed in proportion to time as a potential-current curve is called a potential sweep method, and when the potential is repeatedly applied, it is called cyclic voltammetry. The cyclic voltammetry allows qualitative understanding of a reaction occurring on an electrode surface such as potential at the reaction occurs, reaction speed, and reactivity of a reaction product, and is widely used in the electrochemical field.

As an electrode active material, the compounds of Example 1 and Comparative Examples 1 to 3 were dissolved in 1 M sodium sulfate (Na₂SO₄) at a concentration of 0.01 M and used as an electrolyte solution, and a measurement cell was manufactured by using glassy carbon (3 mm) as a working electrode, Pt wire as a counter electrode, and Ag/AgCl as a reference electrode.

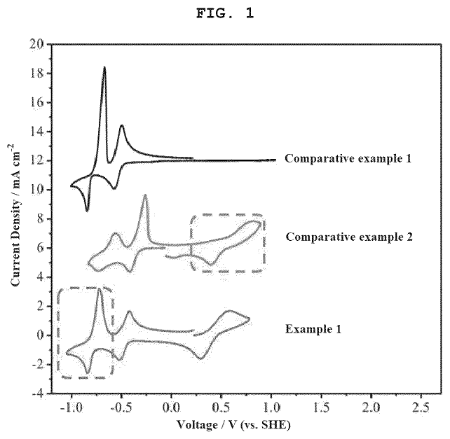

During cyclic voltammetry measurement, a potential scanning speed was applied at 10 to 300 mV/s, and the measurement results are shown in FIGS. 1 to 3.

As shown in FIG. 1, reduction and oxidation currents were confirmed around −0.54 V and −0.75 V which are a negative electrode area in Comparative Example 1, and considering that the behavior of a reaction at −0.75 V which is a second electron reaction was irreversible, it is shown that a range of use as an active material of a battery was to a one-electron reaction of a negative electrode. As such, it is considered that the reason that the reduction reaction of the second negative electrode was irreversible is because the properties of a material to have a charge disappeared during a two-electron reduction, resulting in lowering solubility in water, and the material was unable to react.

In Comparative Example 2, reduction and oxidation currents were confirmed around −0.34 V and −0.65 V which was a negative electrode area, and further, two-electron reduction and oxidation currents derived from hydroquinone were confirmed at 0.59 V which was a positive electrode area. These results were different from the results of Comparative Example 1, and electron reactivity in a positive electrode area was considered as an effect of the added hydroquinone substituent. Thus, it is shown that Comparative Example 2 is able to be used as a positive electrode electrolyte solution unlike Comparative Example 1, but the reversibility and the current density of the two-electron reaction in the negative electrode area of Comparative Example 2 did not reach a target level, and when it was actually used as a negative electrode, two electrons were not used and only one electron was used to show the results that energy density was half and the energy density was low as a battery material.

Example 1 had significantly improved current density of a two-electron reaction in a negative electrode area and showed a reversible shape, as compared with Comparative Example 2. Also, it was confirmed that the two-electron reaction derived from hydroquinone in the positive electrode maintained reversible behavior. In Example 1, a charged ammonium-based substituent was introduced to improve the solubility of the material itself, as compared with Comparative Example 2, and it is considered that the reversibility of the two-electron reaction in the negative electrode area was recovered.

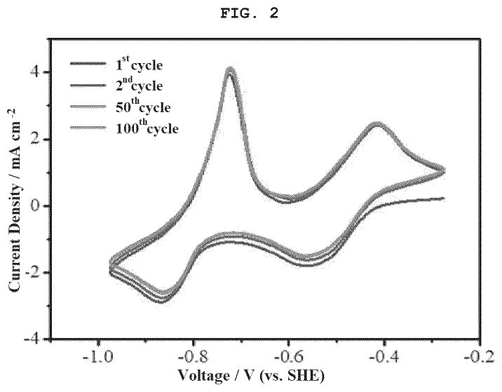

As shown in FIG. 2 in which cyclic voltammetry was measured in a long-term cycle, it is more clearly shown that the reversibility of the two-electron reaction in Example 1 was improved, and it is shown that the current density of the two-electron reaction of the negative electrode in a long-term cycle was maintained to show a reversible two-electron reaction.

In addition, in Example 1, positive electrode reactivity was shown from a hydroquinone substituent, two electrons of the negative electrode were usable by introducing a charged ammonium substituent, as compared with Comparative Example 1, and it is shown that the compound may be used as a single active material having high energy density.

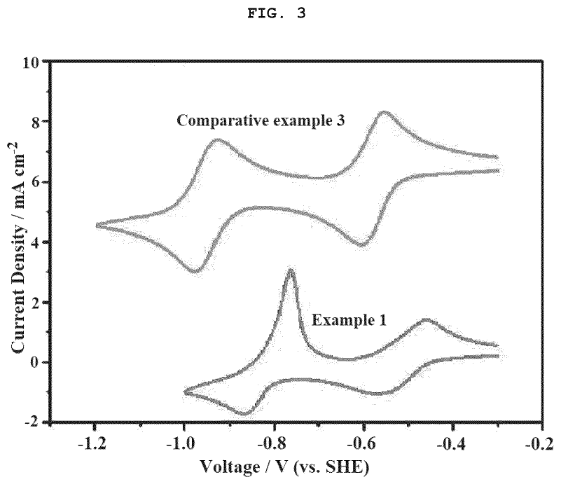

As shown in FIG. 3, in Comparative Example 3 having a charged ammonium substituent, a reversible two-electron negative electrode redox reaction was shown in a similar voltage area, but reversible behavior was not shown in a positive electrode area, but in Example 1 of the present invention, reversible behavior was shown in the positive electrode area.

The results of measuring energy density of Example 1 and Comparative Examples 1 to 3 are shown in Table 1, but since Comparative Example 1 was not a single active material, its energy density was not measured, and it was shown that the energy density of Example 1 was improved by about 8.5 times as compared with Comparative Example 2.

Example 1 of the present invention may solve the problem of long-term lifespan decline due to cross contamination of a flow battery which may arise from Comparative Example 1 which was only available as a one-electron negative electrode active material and showed significantly improved energy density as compared with Comparative Example 2. Thus, Example 1 may be implemented as a single active material having excellent performance which allows a two-electron reaction and shows high energy density.

### Experimental Example 2

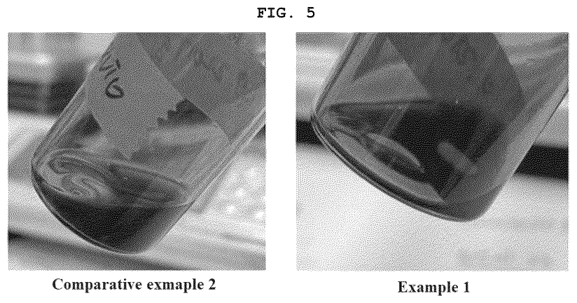

A solubility experiment of Example 1 and Comparative Example 2 was performed, and the results are shown in Table 1 and FIG. 5.

Certain equivalents of the compounds of Example 1 and Comparative Example 2 were added to a vial, a certain amount of water was added thereto at room temperature, and the materials were dissolved, and when dissolved, a certain amount of water was added and the solubility was measured.

The results are shown from the volume of water added until all was dissolved and the mass and molecular weight of the synthesized material initially added, and Example 1 of the present invention showed the results improved by about 3.6 times as compared with Comparative Example 2 and showed significantly improved solubility due to the ammonium substituent.

### Experimental Example 3

The working voltage and the energy density were calculated with the reaction potential and the solubility values of Comparative Examples 1 to 3 and Example 1 which were measured in Experiment Examples 1 and 2, according to the following Equation 1. In Comparative Example 1, it was able to be used only as a negative electrode material and had an energy density value varying depending on the combined positive electrode, its energy density was not able to be determined.

$$Energy density ( Wh {L}^{- 1} ) = \frac{nF}{2 * 3600 sec} * solubility * working voltage$$

(n: the number of electrons participating the reaction, F: a Faraday constant, 96485 (A·sec·mol⁻¹), maximum solubility of material (mol·L⁻¹), working voltage (V))

In Comparative Example 2 in which only one-electron reaction proceeded reversibly, the working voltage was determined from a difference between a positive electrode reaction potential and a negative electrode one-electron reaction potential, and in Example 1 in which a two-electron reaction proceeded, an average working voltage was determined and substituted.

The average working voltage used an average of a difference in reaction potential of a one-electron reaction of the positive electrode and the negative electrode and a difference in reaction potential of a two-electron reaction of the positive electrode and the negative electrode, according to the following Equation 2:

### Equation 2

### Average Working Voltage (V)

=(positive electrode reaction potential−negative electrode one-electron reaction potential)+(positive electrode reaction potential−negative electrode two−electron reaction potential)/2

TABLE 1

| | | Negative | Negative | | | | |
|---|---|---|---|---|---|---|---|
| | Positive | electrode | electrode | | | | |
| | electrode | one-electron | two-electron | | | | |
| | reaction | reaction | reaction | Working | Maximum | Number of | Energy |
| | potential | potential | potential | voltage | solubility | reaction | density |
| | (V vs. NHE) | (V vs. NHE) | (V vs. NHE) | (V) | (M) | electrons | (Wh · L⁻¹) |
| Comparative | — | −0.54 | — | — | — | — | — |
| Example 1 | | | | | | | |
| Comparative | 0.59 | −0.34 | — | 0.93 | 0.63 | 1 | 7.84 |
| Example 2 | | | | | | | |
| Example 1 | 0.46 | −0.48 | −0.80 | 1.10 | 2.27 | 2 | 66.67 |

### [Experimental Example 4] Manufacture and Test of Non-Flow Cell

### (1) Manufacture of Cell

A non-flow cell was first assembled in the order of a glass end plate, an end plate, a Cu-current collector, a graphite bipolar plate, a flow flame, a felt electrode, an AEM separator, a felt electrode, a flow frame, a graphite bipolar plate, a Cu-current collector, an end plate, and a glass end plate so that the positive electrode and the negative electrode became symmetrical. The non-flow cell had a structure using a graphite felt electrode (2*2 cm²) as both electrodes, and the compound of Example 1 was dissolved in 1 M sodium sulfate (NaSO₄) at a concentration of 0.01 M to be used as an electrolyte solution and was loaded on a positive electrode at 0.8 ml and a negative electrode at 0.6 ml. The AEM separator was used after impregnating an anion-exchange membrane in 1 M Na₂SO₄ which was a supporting electrolyte one day before assembly.

### (2) Cell Test

The cell was operated in a voltage range of 1.45 to 0.1 V at the initial cycle under the conditions of 1.45 mA constant current charge/0.322 mA constant current discharge, and after the third cycle, the test was performed under the voltage conditions of 1.15 to 0.0 V. As a charger/discharger, a charger/discharger from Maccor was used.

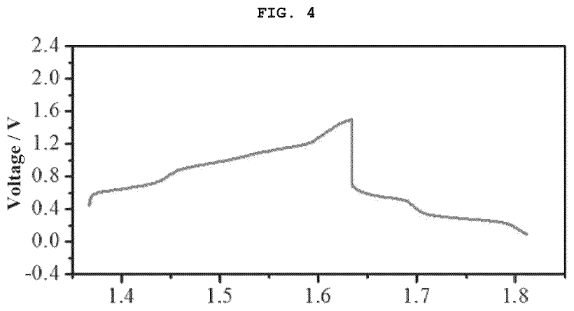

The voltage profile is shown in FIG. 4, and as expected in the two-electron behavior of Example 1, 2 plateaus represented by the two-electron reaction were observed. In addition, considering that it was almost discharged as much as charged, it is shown that the example of the present invention showed excellent electrochemical performance with almost no decline in coulombic efficiency and lifespan due to cross contamination by single active material behavior.

From the results, it is shown that the organic active material of the example of the present invention had improved positive electrode reactivity and solubility and allowed the two-electron reaction by having a specific substituent, and the redox flow battery adopting the material had very improved long-term characteristics and high energy density. In addition, since the organic active material of the present invention is much cheaper than the conventional active material including a vanadium metal, it may be very economically used.

The organic active material according to the present invention may show positive electrode reactivity, a solubility improvement effect, and 2-electron reactivity due to a specific substituent, and a redox flow battery adopting an electrolyte solution including the active material may show long period characteristics and high energy density properties.

In addition, the electrolyte solution of the present invention is an aqueous electrolyte solution and has low risk of fire or explosion to show excellent stability.

Since the organic active material according to the present invention may be applied to a positive electrode and a negative electrode as a single active material, it may recover the capacity by mixing solution even when the capacity of the battery is decreased by active material penetration through a separator, and is much cheaper than an active material used in a conventional flow battery and may be used as an economical single active material.

Hereinabove, although the present invention has been described by specific matters, Examples, and Comparative Examples, they have been provided only for assisting in the entire understanding of the present invention. Therefore, the present invention is not limited to the above Examples. Various modifications and changes may be made by those skilled in the art to which the present invention pertains from this description.

Therefore, the spirit of the present invention should not be limited to the above-described exemplary embodiments, and the following claims as well as all modifications equal or equivalent to the claims are intended to fall within the scope and spirit of the invention.

1. An electrolyte solution for a redox flow battery comprising:
an organic active material including an ionic compound represented by the following Chemical formula 1;
a supporting electrolyte; and
an aqueous solvent: 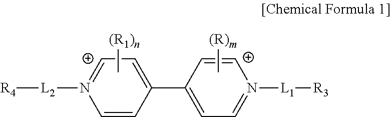
wherein L₁ and L₂ are independently of each other C1-C7 alkylene;
the alkylene may be substituted by halogen, —COORₐ, —SO₃R_{b}, —COR_{c}, or —NR_{d}Rₑ;
Rₐ to Rₑ are independently of one another hydrogen or C1-C5 alkyl;
R₁ and R₂ are independently of each other hydrogen, hydroxy, C1-C7 alkyl, C1-C7 alkoxy, C6-C20 aryl, C5-C20 heteroaryl, or C6-C20 aryloxy;
R₃ is —(N (Rₚ) (R_{q}) (Rᵣ))⁺, —SO₃⁻, —COO⁻, or —PO₃²⁻;
Rₚ to Rᵣ are independently of one another C1-C7 alkyl;
R₄ is 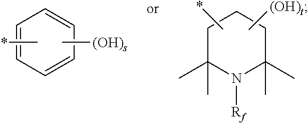
R_{f} is hydrogen or hydroxy;
n and m are independently of each other an integer of 1 to 4;
s is an integer of 1 to 5; and
t is an integer of 1 or 2.

2. The electrolyte solution for a redox flow battery of claim 1, wherein the organic active material comprises an ionic compound represented by the following Chemical Formula 2: 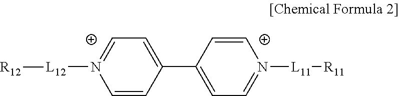
wherein
L₁₁ and L₁₂ are independently of each other C1-C7 alkylene;
the alkylene may be substituted by halogen, —COORₐ, —SO₃R_{b}, —COR_{c}, or —NR_{d}Rₑ;
Rₐ to Rₑ are independently of one another hydrogen or C1-C5 alkyl;
R₁₁ is —(N (Rₚ) (R_{q}) (R_{d}))⁺, —SO₃⁻, —COO⁻, or —PO₃²⁻;
Rₚ to Rᵣ are independently of one another C1-C7 alkyl;
R₁₂ is 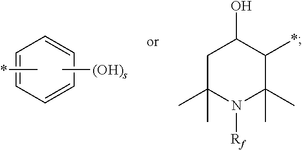
R_{f} is hydrogen or hydroxy; and
s is an integer of 1 to 3.

3. The electrolyte solution for a redox flow battery of claim 1, wherein the organic active material comprises an ionic compound represented by the following Chemical Formula 3: 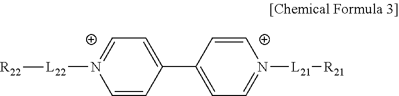
wherein
L₂₁ and L₂₂ are independently of each other C1-C5 alkylene;
the alkylene may be substituted by halogen, —COORₐ, —SO₃R_{b}, —COR_{c}, or —NR_{d}Rₑ;
Rₐ to Rₑ are independently of one another hydrogen or C1-C5 alkyl;
R₂₁ is —(N (Rₚ) (R_{q}) (R_{d}))⁺, —SO₃⁻, —COO⁻, or —PO₃²⁻;
Rₚ to Rᵣ are independently of one another C1-C5 alkyl; and
R₂₂ is

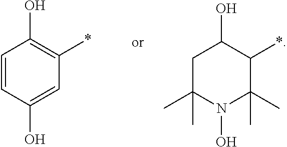

4. The electrolyte solution for a redox flow battery of claim 3,
wherein in Chemical Formula 3, L₂₁ and L₂₂ are independently of each other C1-C3 alkylene;
the alkylene may be substituted by halogen, —COORₐ, —SO₃R_{b}, —COR_{c}, or —NR_{d}Rₑ;
Rₐ to Rₑ are independently of one another hydrogen or C1-C3 alkyl; and
Rₚ to Rᵣ are independently of one another C1-C3 alkyl.

5. The electrolyte solution for a redox flow battery of claim 1, wherein the ionic compound is selected from the following compounds:

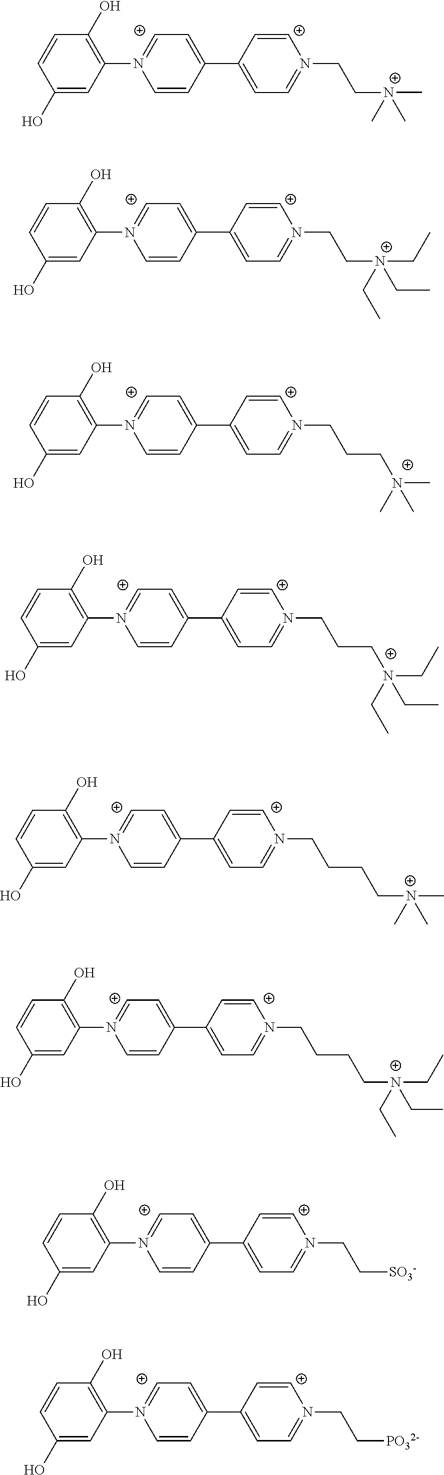

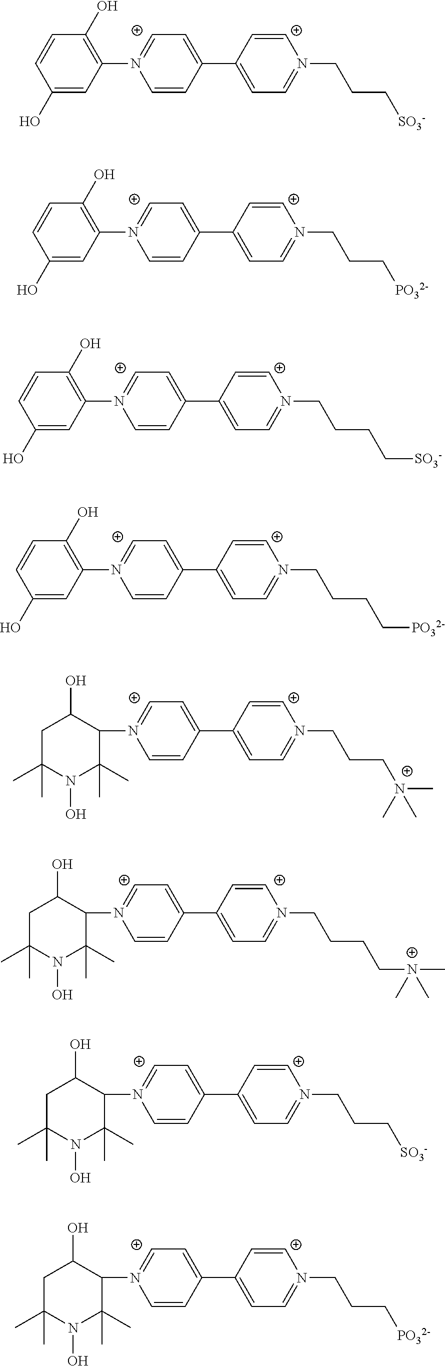

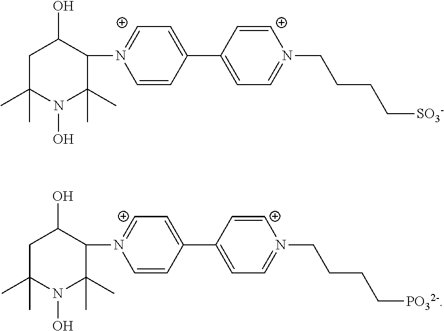

6. The electrolyte solution for a redox flow battery of claim 1, wherein the organic active material is used alone in a positive electrode and a negative electrode.

7. The electrolyte solution for a redox flow battery of claim 1, wherein the organic active material is comprised at a concentration of 0.001 to 4.0 M based on a total electrolyte solution.

8. The electrolyte solution for a redox flow battery of claim 1, wherein the supporting electrolyte is one or two or more selected from H₂SO₄, Li₂SO₄, Na₂SO₄, K₂SO₄, and LiCl.

9. The electrolyte solution for a redox flow battery of claim 1, wherein the supporting electrolyte is comprised at a concentration of 0.5 to 3.0 M based on a total electrolyte solution.

10. A redox flow battery comprising:
a positive electrode cell comprising the electrolyte solution of claim 1 and a positive electrode;
a negative electrode cell comprising the electrolyte solution of claim 1 and a negative electrode; and
a separator between the positive electrode cell and the negative electrode.

11. The redox flow battery of claim 10, wherein the separator is an anion exchange membrane or a porous membrane.
